(19) United States
(12) Patent Application Publication
(10) Pub. No.: US 2008/0082378 A1
(43) Pub. Date: Apr. 3, 2008

(54) Logistics start-up method

(76) Inventors: Joshua Scott Duncan, Pekin, IL (US); Carl Christian Block, Peoria, IL (US); Michael F. Crompton, East Peoria, IL (US); Cassandra Lea Osborne, East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/528,578

(22) Filed: Sep. 28, 2006

(51) Int. Cl. G06F 17/50

(52) U.S. Cl. 705/7

(57) ABSTRACT

A method for implementing a new logistics program includes executing a plurality of start-up model phases for the new logistics program, the start-up phases including at least a program development phase, a pilot phase, a go-live phase, and a transition phase. During the program development phase, logistics processes are selected, for the pilot, go-live, and transition phases, to be reviewed during each respective phase. Furthermore, a communication plan is selected to execute between a program developer entity and a program client entity during each respective phase. The new logistics program is piloted during the pilot phase, according to the processes and the communication plan selected for the pilot phase, operated in real-time during the go-live phase, according to the processes and the communication plan selected for the go-live phase, and transitioned to self-sufficient operation during the transition phase, according to the processes and communication plan selected for the transition phase.

### TECHNICAL FIELD

The present disclosure relates generally to logistics start-ups, and more particularly, to implementing logistics programs using a logistics start-up method.

### BACKGROUND

Companies and other entities often hire logistics developers to implement logistics services and/or products for their businesses. For example, retail stores may hire logistics developers to build and “start up” new warehouses for receiving, storing, and distributing inventory. For a new logistics program (e.g., logistics products and/or services), a developer and client may agree to implement the new program, resulting in a sale of logistics products and/or services. Typically, after the sale is made, the developer implements the new program with minimal or no input from the client. Thus, for example, the developer may install and operate logistics services for a new warehouse using its own logistics equipment, employees, processes, and review procedures to run the warehouse.

Implementing new logistics programs typically requires performing certain steps. These steps may include, for example, designing the new logistics program, installing the logistics program, and running the logistics program. Logistics developers typically use their own tools, employees, and processes to execute each of the steps necessary to implement the new program. For example, a logistics developer may use its own warehouse logistics design team to design the warehouse, may order logistics tools for the warehouse, and may create a logistics service plan for warehouse operations.

Although starting up new logistics programs typically includes a number of implementation steps, companies fail to use the same structured set of steps to implement logistics programs across a diverse set of new logistics programs. As a result, logistics developers struggle to pinpoint problem areas in the new program implementation process. Consequently, improvements to the start-up procedure for future new programs occur more slowly than desired. In addition, because implementing new logistics programs typically does not include significant client input and feedback, these new logistics programs often fail to satisfy the client's expectations.

One method of improving the start-up of new programs is described in U.S. Patent Application Publication No. 2001/0032105, to Frye et al., published on Oct. 18, 2001 (the '105 application). The '105 application describes a method and system for introducing a new project initiative into a business. The method employs a systematic series of stages, milestones, and checklists for initiating a new project, including a series of “tollgates” and a set of new project implementation stages. Although the '105 application describes a uniform process for designing and implementing new projects such as manufacturing and design projects, it fails to address a procedure for implementing new logistics programs. Consequently, the '105 application does not address the developer-client communication disconnect that often occurs when implementing new logistics programs. As a result, the methods described in the '105 application fail to solve the communication problems, development inefficiencies, and slow improvement rates associated with starting up typical logistics programs.

The disclosed start-up method is directed to overcoming one or more of the problems set forth above.

### SUMMARY OF THE INVENTION

In one embodiment, a method for implementing a new logistics program is provided. The method includes executing a plurality of start-up model phases for the new logistics program, the start-up phases including at least a program development phase, a pilot phase, a go-live phase, and a transition phase. The method further includes selecting, during the program development phase, logistics processes to be reviewed during each of the respective pilot, go-live, and transition phases. In addition, a communication plan is selected to execute between a program developer entity and a program client entity during each respective phase. The new logistics program is then piloted during the pilot phase, according to the processes and the communication plan selected for the pilot phase, operated in real-time during the go-live phase, according to the processes and the communication plan selected for the go-live phase, and transitioned to self-sufficient operation during the transition phase, according to the processes and communication plan selected for the transition phase.

In a second embodiment, a method for implementing a new logistics program is provided. The method includes executing a plurality of start-up program phases for the new logistics program, the start-up program phases including at least a program development phase, a pilot phase, a go-live phase, and a transition phase. The method further includes, during the program development phase, providing one or more review members to select, for each of the pilot, go-live, and transition phases, processes to review for the respective phase and a communication plan to execute between a program developer entity and a program client entity during the respective phase. The method additionally includes providing one or more pilot members to pilot the new logistics program during the pilot phase, according to the processes and the communication plan selected for the pilot phase, providing one or more operation members to conduct real-time operation of the new logistics program during the go-live phase, according to the processes and the communication plan selected for the go-live phase, and providing one or more transition members to transition the new logistics program, during the transition phase, from the go-live phase to self-sufficient logistics operation, according to the processes and the communication plan selected for the transition phase.

### BRIEF DESCRIPTION OF THE DRAWINGS

FIG. 1 is a block diagram illustrating an exemplary communication environment consistent with certain disclosed embodiments;

FIG. 2 is a diagram illustrating an exemplary start-up model consistent with certain disclosed embodiments; and

FIG. 3 is a flow chart illustrating an exemplary start-up method consistent with certain disclosed embodiments.

### DETAILED DESCRIPTION

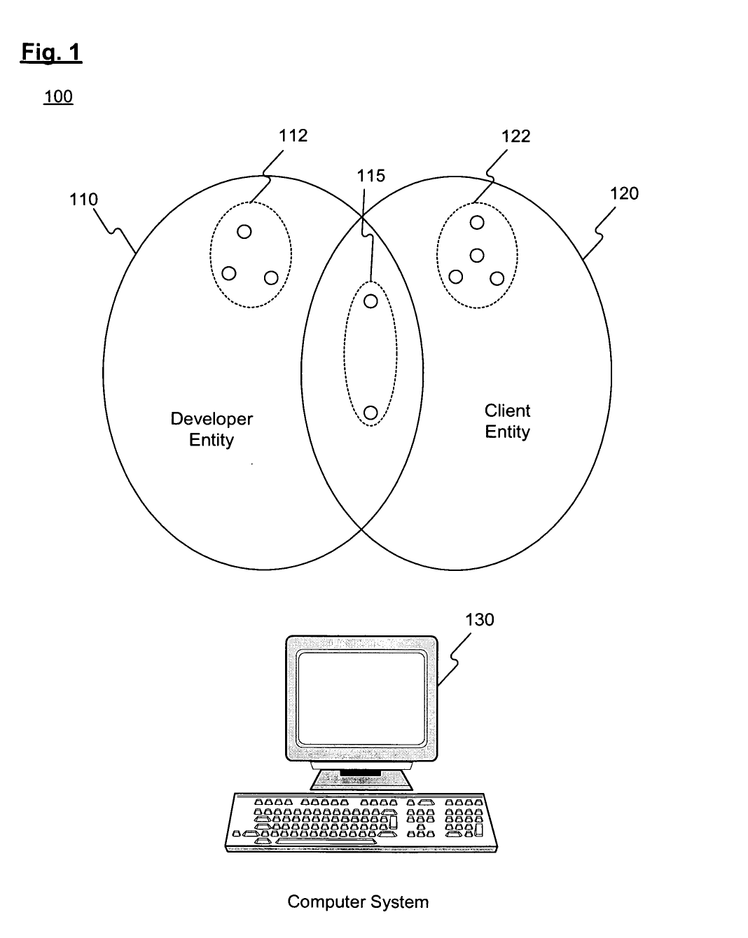

FIG. 1 depicts an exemplary communication system 100 for implementing one or more disclosed embodiments. System 100 includes developer entity 110, client entity 120, and computer system 130. However, system 100 is only one exemplary embodiment. Other embodiments may include any number of developer entities or client entities, or a single entity that includes one or more developer entities and one or more client entities. In addition, computer system 130 may include any number of computer systems, computer networks, or other data processing systems. Alternatively, computer system 130 may not be present in system 100.

Developer entity 110 may be any company, individual, corporation, governmental agency, non-profit organization, or other group, that provides logistics products, services, processes, development, etc. (hereinafter “programs”) to clients. In one embodiment, developer entity 110 is a logistics group within a larger company. Developer entity 110 includes one or more members 112. Members 112 may include employees of developer entity 110, consultants to developer entity 110, third party contractors hired by developer entity 110, and/or any other group that provides logistics programs on behalf of developer entity 110 to a client. Members 112 may include a plurality of people, or may include a single person.

Client entity 120 may be a company, individual, corporation, governmental agency, non-profit organization, or other group, that uses one or more logistics programs implemented by developer entity 110. In one embodiment, client entity 120 is a retailer, wholesaler, or seller of other products, who requires the use of a warehouse or other storage facility to carry out some or all of its operations. In this embodiment, developer entity 110 provides one or more warehouse logistics programs to client entity 120. These warehouse logistics programs help client entity 120 more efficiently operate its warehouse. Although warehouse logistics are described throughout this specification, they are merely one example of logistics services that may benefit from the disclosed start-up model. The disclosed start-up model may be used for any known type of logistics program. Client entity 120 includes one or more members 122. Members 122 may include employees of client entity 120, consultants to client entity 120, third party contractors hired by client entity 120, employees of developer entity 110 hired by client entity 120 to operate logistics programs, or any other individual or group that operates logistics programs implemented using the disclosed start-up model. Members 122 may include a plurality of people, or may include a single person.

Members 115 include a group having one or more members selected from developer entity 110 and one or more members selected from client entity 120. In one embodiment, members 115, also referred to as “start-up team” 115, work together to implement a new logistics program for client entity 120. In one embodiment, start-up team 115 includes working team members (e.g., members who actively participate in constructing and/or operating logistics processes) and stakeholder members (e.g., members who review the start-up progress and have a business interest in the outcome of the new logistics program). Stakeholders may also be working team members.

Computer system 130, which in one embodiment is included in system 100, may be one or more stand-alone personal computers, laptop computers, personal digital assistants (PDAs), computer workstations, cellular phones, or other processing and/or communication devices. In one embodiment, computer system 130 is part of a network of computers (e.g., the Internet) that provides communication services between developer entity 110 and client entity 120. Computer system 130 includes hardware, firmware, and/or software configured to allow one or more users to enter, manipulate, store, analyze, delete, etc., information related to one or more logistics programs. In one embodiment, computer system 130 uses a software application program to perform these tasks, such as Microsoft Project™, offered by Microsoft Corp., of Redmond, Wash.

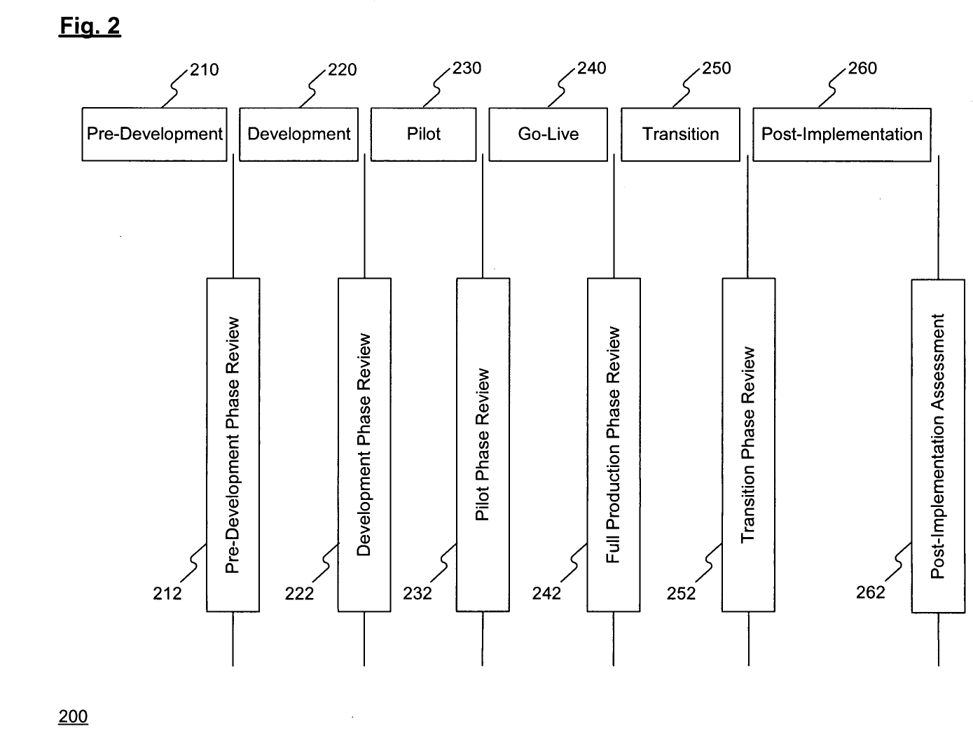

FIG. 2 depicts an exemplary start-up model 200 for a new logistics program, consistent with certain disclosed embodiments. The start-up model includes a plurality of phases for implementing a new logistics program. In one embodiment, each phase is concluded with a “gate” review, at which point a team of members reviews a number of tasks undertaken during the phase to determine whether the certain pre-set parameters have been reached (e.g., whether a start-up process has been completed, has achieved certain metrics, etc.). If the phase has been implemented to the team's satisfaction, the new program may proceed to the next phase. The phases in the start-up model include pre-development phase 210, development phase 220, pilot phase 230, go-live phase 240, transition phase 250, and post-implementation phase 260. Accordingly, the gate reviews may include pre-development review 212, development phase review 222, pilot phase review 232, full production phase review 242, transition phase review 252, and post-implementation assessment 262. Following each gate review, the new logistics program either continues to the next phase (e.g., if the gate review is satisfactory) or remains in the same phase to improve processes included in that phase.

During pre-development phase 210, developer entity 110 and client entity 120 discuss implementing a new logistics program for client entity 120 and agree to implement the new program. In one embodiment, pre-development phase 210 includes a number of tasks. These tasks may include, for example, determining the scope of the logistics processes included in the new logistics program; determining a duration for each process (e.g., number of months to build a warehouse, number of weeks to train new employees, etc.); developing a timeline for implementing the new logistics program based on the determined durations, including developing a timeline for each phase of the start-up model; developing a work breakdown structure for program management (e.g., structuring planned tasks in an orderly manner); determining and assigning resources to be used for implementing the new program (e.g., materials, tracking software, employees, etc.); determining who is responsible and/or accountable for specific tasks during the program's start-up; reviewing the client's current and future expected business state; developing a recognition plan for employees; determining critical customer requirements and business requirements (e.g., claims per line of goods, etc.); and developing a “change management plan” regarding how to best transition from old resources and employment positions to new resources and employment positions during the program's start-up.

In addition, during pre-development phase 210, developer entity 110 and client entity 120 may discuss and develop a communication plan to be used throughout the different phases of the start-up model. For example, developer entity 110 and client entity 120 may determine how often to meet, where and when to meet, and who will be involved in the communications. In one embodiment, at least one member of developer entity 110 and at least one member of client entity 120 are scheduled to meet on a regular basis to discuss progress during start-up of the new program. The communication plan may additionally designate who will be included in gate reviews for each party. In one embodiment, the same team is selected for all gate reviews throughout the start-up procedure, in order to ensure that both parties have a complete understanding of the new logistics program. However, different teams may be selected for different gate reviews. In one embodiment, during pre-development phase 210, developer entity 110 and client entity 120 may review prior agreed-upon contractual terms for the logistics program.

Associated with pre-development phase 210 is pre-development gate review 212. During pre-development gate review 212, a review team including one or more members of developer entity 110, one or more members of client entity 120, or a combination of members from developer entity 110 and client entity 120 (e.g., selected from start-up program team 115) reviews the new program's progress during pre-development phase 210. In one embodiment, in order to facilitate communication between the developer entity and the client entity, the gate reviews are performed by a review team including one or more members from both developer entity 110 and client entity 120 (e.g., selected from start-up program team 115). In addition, because stakeholders of developer entity 110 and/or client entity 120 have a vested interest in the outcome of the new logistics program, one or more stakeholders may be included in the review team as well.

Various tasks executed during pre-development phase are reviewed during pre-development gate review 212. In one embodiment, the review team checks whether these tasks have been completed to the review team's satisfaction. For example, the team may check whether a schedule has been developed which the team believes is achievable. The team may review the contract and the resources assigned to determine exactly what was sold and whether the expected resources will be sufficient to fulfill the contractual terms. The team may also review the communication plan to ensure that both developer entity 110 and client entity 120 will be accurately informed of the new program's progress throughout the various phases of the start-up model. Other information related to pre-development phase tasks may be reviewed and validated as well (e.g., critical customer requirements, change management plan, work breakdown structure, etc.). If the review team decides that the implementation plan is satisfactory, then implementation begins, and the start-up program enters development phase 220.

During development phase 220, a development team that includes one or more members of development entity 110 and one or more members of client entity 120 (e.g., selected from start-up team 115) constructs a preliminary logistics system and develops a review process for the new logistics program's implementation (e.g., for the remaining phases of the start-up model for the new program). A number of tasks are performed during development phase 220. In one embodiment, these tasks include constructing a logistics system for the logistics program (e.g., building a warehouse, purchasing equipment, hiring employees, etc.). In addition, during development phase 220, the development team may execute the work breakdown structure, communication plan, and other processes determined in pre-development phase 210. These processes may be executed in accordance with the schedule determined in pre-development phase 210. During development phase 220, the development team may additionally develop a logistics process review plan for reviewing logistics processes to be executed during the logistics program. The review plan may be used to review logistics processes during one or more of the phases of the start-up model. In one embodiment, a development team performs failure mode and effects analysis (FMEA) during development phase 220. During FMEA, a team may determine risks resulting from different processes included in the logistics program, and may determine who is responsible and/or accountable for the risks. Risks may include business risks (e.g., risks of losing money due to logistics processes that may create inefficiencies, etc.), as well as physical risks (e.g., physical risks to employees due to equipment, etc.). The risks may then be evaluated in subsequent phases of the start-up model to ensure that the new program is within its risk limits.

The development team may also develop “grief” procedures (e.g., how to handle process exceptions such as incorrect part deliveries, warehouse equipment malfunctions, etc.). These grief procedures may be employed and evaluated throughout the different phases of the start-up model. Additionally, the development team may develop safety procedures to be followed and/or assessed throughout one or more of the start-up model phases.

Associated with development phase 220 is development phase gate review 222. During development phase gate review 222, a review team including one or more members of developer entity 110, one or more members of client entity 120, or a combination of members from developer entity 110 and client entity 120 (e.g., selected from start-up team 115) reviews the new program's progress during development phase 220. In one embodiment, the review team may include one or more stakeholders of developer entity 110 and/or client entity 120.

Various processes and metrics are reviewed during development phase gate review 222. For example, in one embodiment, a review team reviews the tasks executed during development phase 220, and may verify whether executed processes comply with the critical customer requirements and work breakdown structure determined in pre-development phase 210. Additionally, the review team may review and/or adjust risk values determined during FMEA based on its review of the logistics program processes executed during development phase 220. The team may also review the grief procedures established during development phase 220, and may additionally compare projected versus actual scheduling times to determine whether the new program is following its start-up model timeline. Resource constraints and other concerns may be reviewed during development phase gate review 222 as well. In one embodiment, during development phase 220 and development phase gate review 222, the review team follows the communication plan set in pre-development phase 210.

If a reviewed logistics process is approved by the review team for a particular phase, the process may be referred to as having reached its “milestone.” In one embodiment, if a certain number or percentage of the logistics processes fail to achieve their milestones (e.g., one or more processes fail to reach their milestones, 20% of processes fail to reach their milestones, etc.), then improvements may be made to the processes, and the new program may remain in development phase 220. However, if the review team determines that a sufficient number of the logistics processes achieve their milestones, then development phase 220 is complete, and the new program enters pilot phase 230.

Although pre-development phase 210 and development phase 220 are depicted in FIG. 2 as separate phases, the two phases may be referred to as a single “program development” phase, as both include processes designed to develop a plan and infrastructure for implementing the new program. Thus, the “program development” phase may include one or more of the tasks described in pre-development phase 210 and/or development phase 220. As such, in one embodiment, prior to the “pilot” phase (discussed below), a program development team (e.g., selected from members of start-up team 115) determines risks and/or safety hazards to review at subsequent phases of the start-up model, determines logistics processes to review at subsequent phases of the start-up model (e.g., metrics to collect and later review for different logistics processes), and a develops communication plan to execute between a program developer entity and a program client entity for each phase of the start-up model.

During pilot phase 230, the new logistics program is executed in a controlled environment to test the program developed in development phase 220 (or alternatively, in the “program development phase”). Certain tasks are executed during pilot phase 230. For example, in one embodiment, pilot phase 230 includes hiring and training of staff to execute the new logistics program, executing the new logistics program in a controlled environment, and making improvements to the new logistics program. In one embodiment, pilot phase 230 is executed by members of developer entity 110 and/or members of client entity 120, and is aided by a support team supplied by developer entity 110. The support team may include, for example, members of developer entity 110 who are experts or highly experienced in logistics development and implementation and/or who are experts or highly experienced in a particular logistics industry (e.g., warehousing). The support team may include other logistics supporting members as well.

In one embodiment, a number of tasks are executed during pilot phase 230. For example, the new logistics program developed in development phase 220 may be executed. Because this execution may be the first test-run of the logistics program, it may have certain problem areas. As a result, a pilot team may document potential improvements discovered during one or more program testing periods. During pilot phase 230, a pilot team may also develop logistics documentation (e.g., manuals, guidebooks, etc., to be used by employees involved with the logistics program). The pilot team may additionally train staff and other employees, plan a detailed go-live timeline and volume output plan, run and review one or more stress tests to the logistics system, improve and finalize a process reporting and control plan for the logistics program, and/or perform additional risk and/or safety analysis for the new logistics program. In one embodiment, the same risk and/or safety factors and processes determined in development phase 220 may be reviewed during pilot phase 230. Further, the developer entity 110 and client entity 120 may communicate according to the communication plan established during pre-development phase 210.

Associated with pilot phase 230 is pilot phase gate review 232. During pilot phase gate review 232, a review team including one or more members of developer entity 110, one or more members of client entity 120, or a combination of members from developer entity 110 and client entity 120 (e.g., selected from start-up team 115) reviews the new program's progress during pilot phase 230.

Various processes and metrics are reviewed during pilot phase gate review 232. For example, the risks and/or safety measures set forth during development phase may be re-evaluated. New risks and/or safety measures may be evaluated as well. The review team may determine whether the new program is likely to comply with the risk and/or safety factors set, and may suggest changes based on the team's analysis. The review team may additionally review a number of logistics processes implemented during the pilot phase (e.g., operating certain machinery, tracking inventory, etc.) to determine whether the processes comply with the work breakdown structure, schedule, critical customer requirements, and other requirements set during pre-development phase 210 and/or development phase 220. In doing so, a review team may follow the process review plan established during development phase 220 and/or the communication plan established during pre-development phase 210.

During the pilot phase gate review, certain processes and metrics may be compared to particular milestones set for the processes. For example, the pilot review team may check whether the pilot team followed the established communication plan, whether all documentation has been finalized, whether a logistics stress test has resulted in favorable results, whether risk factors and/or safety measures are within an acceptable range, whether a certain percentage of logistics program staff has been trained, etc. If a certain number or percentage of the logistics processes fail to achieve their milestones (e.g., one or more processes fail to reach their milestones, 20% of processes fail to reach their milestones, etc.), then improvements may be made to the processes, and the new program may remain in pilot phase 230. However, if the review team determines that a sufficient number of the logistics processes achieve their milestones, then pilot phase 230 is complete, and the new program enters go-live phase 230.

During go-live phase 240, the new logistics program is executed using real-time, actual interaction with outside entities (e.g., making sales and/or purchases to/from companies, agencies, corporations, or other entities), but in a limited capacity. For example, for a new warehouse, a limited number of items to be sold to outside vendors may be received and stored in the warehouse, and may be sold and delivered to outside vendors. Logistics processes (e.g., storing items within a warehouse, monitoring inventory & sales, monitoring any losses or damaged goods, etc.) are performed based on the movement of these items. In one embodiment, go-live phase 240 includes a support team (e.g., a team as described above in connection with pilot phase 230).

Various tasks are executed during go-live phase 240. For example, processes and procedures established in previous phases (e.g., grief procedures, reporting and control plans, risk and/or safety assessments) may be executed. Furthermore, other logistics processes performed during pilot phase 230 and improvements to the processes may be executed in go-live phase 240. In one embodiment, the communication plan established in pre-development phase 210 is also followed.

Associated with go-live phase 240 is full production phase gate review 242. During full production phase gate review 242, a review team including one or more members of developer entity 110, one or more members of client entity 120, or a combination of members from developer entity 110 and client entity 120 (e.g., selected from start-up team 115) reviews the new logistics program's progress during go-live phase 240 to determine whether the new program is ready for full production.

Various processes and metrics are reviewed during full production gate review 242. For example, the go-live review team may check whether the go-live team followed the established communication plan, whether grief procedures were followed correctly, whether risk factors remain within an acceptable range, whether the new logistics program is following the established start-up schedule, etc. Examples of metrics that may be reviewed during full production gate review 242 include, for example, whether the number of claims per line of goods is within the pre-set parameters, whether warehoused items are delivered within a certain average time period from the order date, whether the number of items stored in the warehouse is above or below a particular level, etc. Any known metric associated with logistics systems may be collected and reviewed during full production review 242.

Various milestones may be set for the processes reviewed during full-production review 242. If a certain number or percentage of the reviewed logistics processes fail to achieve their milestones (e.g., one or more processes fail to reach their milestones, 20% of processes fail to reach their milestones, etc.), then improvements may be made to the processes, and the new program may remain in go-live phase 240. However, if the review team determines that a sufficient number of the logistics processes achieve their milestones, then go-live phase 240 is complete, and the new program enters transition phase 250.

During transition phase 250, the new logistics program is executed for full production using real-time, actual interaction with outside entities. The full production logistics program is then transitioned from a program that uses a support team (e.g., a team as described above in connection with pilot phase 230), to a program that is self-sufficiently run without any support from the support team.

A number of tasks are executed during transition phase 250. For example, processes and procedures established in previous phases (e.g., grief procedures, reporting and control plans, risk assessments) may be executed. Furthermore, the logistics processes performed during pilot phase 230 and/or go-live phase 240 and improvements to these processes may be executed in transition phase 250. In one embodiment, risk evaluations, safety measures, and a communication plan are also followed, according to the methods established during development phase 220 and pre-development phase 210. Transition phase 250 may also include updating and improving any documentation used for the logistics program (e.g., user manuals, training guides, etc.), and making additional logistics process improvements. Additionally, during transition phase 250, the support team prepares the developer entity members 112 and/or client entity members 122 to self-sufficiently operate the logistics program.

Associated with transition phase 250 is transition phase gate review 252. During transition phase gate review 252, a review team including one or more members of developer entity 110, one or more members of client entity 120, or a combination of members from developer entity 110 and client entity 120 (e.g., selected from start-up team 115) reviews the new program's progress during transition phase 250 to determine whether the new program is ready to be operated self-sufficiently (e.g., without the aid of any support team).

Various processes and metrics are reviewed during transition phase gate review 252. For example, in one embodiment, the transition phase review team may verify whether all program documentation is complete for self-sufficient use. The review team may also review any previous metrics and/or processes for compliance with standards set in earlier phases. The transition phase review team may also verify whether the communication plan was sufficiently followed such that the members who will operate the logistics program without a support team are adequately informed of the program's operation. The review team may also verify that the client is comfortable with the transition, and may ensure that all support team members have disengaged in the program's operation. In one embodiment, during transition phase gate review 252, the transition review team verifies a schedule for the post implementation assessment (described below).

If the review team determines that the start-up program is ready to operate self-sufficiently (e.g., all reviewed processes are satisfactory and all metrics have been achieved), then the new program is complete, and the start-up model enters post-implementation phase 260. Accordingly, during post-implementation phase, the new program is operated by members of developer entity 110, members of client entity 120, and/or other individuals acting under client entity 120's control, without the aid of a separate support team. At this point, the new logistics program is established and is no longer a “start-up” program.

As discussed above, each gate review may be implemented by one or more members of developer entity 110, one or more members of client entity 120, or a combination of members from developer entity 110 and client entity 120. In a preferred embodiment, however, in order to facilitate communication between the developer entity and the client entity, the gate reviews are performed by at least one member from developer entity 110 and at least one member from client entity 120.

During post implementation phase 260, the new logistics program is executed self-sufficiently (e.g., without a separate support team supplied by developer entity 110) at full production. In one embodiment, after the post-implementation phase 260 has been in progress for some period of time (e.g., 90 days, 120 days, etc.), developer entity 110 executes a post-implementation assessment 262. During the post-implementation assessment, developer entity 110 reviews the new program's progress by reviewing a number of metrics. In an embodiment that includes warehouse logistics, these metrics may include operation metrics, cost metrics, time metrics, client metrics, and/or employee metrics. Operational metrics may include, for example, claims (e.g., incorrect items delivered) per a certain number of transactions, number of bin denials (e.g., items not available when ordered) per a certain number of transactions, amount of lost inventory, percent of operational logistics processes followed, etc. Cost metrics may includes, for example, budget versus spending comparisons, volume of inventory in the warehouse (e.g., value and number of items), space utilization (e.g., volume of space used), operational costs (e.g., cost per unit shipped), etc. Time metrics may include, for example, inbound and outbound velocity of part movement, productivity of staff per unit time, etc. Client metrics may include, for example, client satisfaction survey results, client manager satisfaction results, etc. Employee metrics may include, for example, training completion metrics, safety assessment metrics, employee attrition, number of employees, etc. These metrics may be assessed during the post-implementation assessment to determine whether the new program is operating as expected. Results of the assessment may then be used to improve the start-up model for future new program implementations.

In one embodiment, metrics assessed for one or more gate reviews or for the post-implementation assessment may coincide with terms of a contract reviewed during the pre-development phase or development phase (e.g., space utilization, operation costs, bin denials, etc.). By tying the contractual terms to the metrics used for assessment purposes, the start-up model provides mechanisms that monitor whether contract terms are honored.

In one embodiment, only one post-implementation assessment is executed. However, in other embodiments, a plurality of post-implementation assessments (e.g., 5 assessments, 10 assessments, periodic annual assessments, bi-annual assessments, etc.) may be executed.

In one embodiment, a record of information collected for the new program via the start-up model is stored so that developer entity 110 may later analyze the processes used during the start-up implementation process. As such, developer entity 110 can pinpoint specific processes that need improvement, and may use the analyses to recommend and implement improved start-up model tasks and processes during future new program implementations.

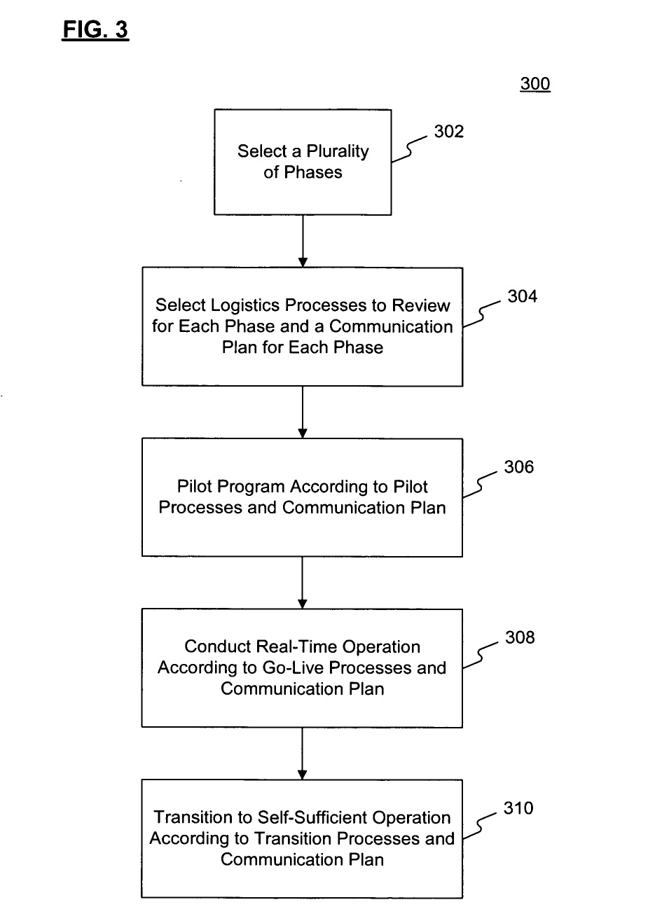

FIG. 3 illustrates an exemplary method 300 consistent with one or more embodiments. At step 302, a plurality of phases are selected in a start-up model for a new logistics program. These phases may include, for example, one or more of the pre-development, development, pilot, go-live, transition, and post-implementation phases discussed above. In one embodiment, the selection of these phases is agreed upon by one or more entities (e.g., a developer entity, client entity, third-party entity, etc.).

At step 304, one or more processes for the new logistics program are selected to be reviewed in each phase, and a communication plan is selected for each phase. The processes and communication plans may be any of those discussed above in connection with the different phases described in connection with start-up model 200. In one embodiment, the processes and communication plan are selected in an initial pre-development and/or development phase by a team that includes at least one member of a development entity and one member of a client entity.

At step 306, the new logistics program enters a pilot phase, and is piloted according to the pilot processes and communication selected in step 304. The pilot phase may include any of the processes discussed above in connection with pilot phase 230. At step 308, the new logistics program enters a go-live phase for conducting real-time operations according to the go-live processes and communication plan selected in step 304. The go-live phase may include any of the processes discussed above in connection with go-live phase 240. At step 310, the new logistics program enters a transition phase for transitioning to self-sufficient operation according to the transition processes and communication plan selected in step 304. The transition phase may include any of the processes discussed above in connection with transition phase 240. During step 310, a support team may initially help transition the new logistics program from go-live phase to a self-sufficient phase. Accordingly, method 300 provides a structured procedure for starting up a new logistics program from the initial pre-development phase to a final self-sufficient phase.

One or more, or all, of the process steps of method 300 may be performed using a computer system, processor, software, etc., associated with system 100. For example, an entity or user associated with developer entity 110 and/or client entity 120 may use computer system 130 with software to perform one or more of the processes described above. Additionally, each entity or user may use separate computer systems and/or software to execute tasks related to the processes described above, consistent with the disclosed embodiments.

### INDUSTRIAL APPLICABILITY

The start-up method described in connection with the disclosed embodiments may be used for any logistics start-up program. For example, in one embodiment, the start-up method may be used for warehouse logistics relating to a new warehouse. A start-up model for warehouse logistics may include, for example, start-up phases related to one or more of: building the warehouse, installing logistics equipment in the warehouse, hiring and training employees to run the logistics program, and running the warehouse logistics program.

The logistics start-up methods described herein may be used for other logistics programs as well, such as order management, materials management, transportation services, customs management, manufacturing logistics, business services, new employee training, or any other logistics products, services, or processes. Furthermore, the logistics methods described herein may be used for logistics programs run, owned, and/or controlled by any entity or combination of entities (e.g., developer entity, client entity, third-party supplier entity, contracting entity, etc.).

The logistics start-up methods described herein advantageously include the same phases and similar processes across different logistics start-up programs, thereby maintaining uniform data analysis across gate reviews. As a result, a logistics provider using the start-up method described herein can more precisely determine problems with different processes of the start-up process.

It will be apparent to those skilled in the art that various modifications and variations can be made to the logistics start-up method described herein. Other embodiments will be apparent to those skilled in the art from consideration of the specification and practice of the disclosed logistics start-up method. It is intended that the specification and examples be considered as exemplary only, with a true scope being indicated by the following claims and their equivalents.

What is claimed is:

1. A method for implementing a new logistics program, comprising:
executing a plurality of start-up model phases for the new logistics program, the start-up phases including at least a program development phase, a pilot phase, a go-live phase, and a transition phase;
during the program development phase, selecting, for each of the pilot, go-live, and transition phases, logistics processes to review during the respective phase and a communication plan to execute between a program developer entity and a program client entity during the respective phase;
piloting the new logistics program during the pilot phase, according to the processes and the communication plan selected for the pilot phase;
conducting real-time operation of the new logistics program during the go-live phase, according to the processes and the communication plan selected for the go-live phase; and
transitioning the new logistics program, during the transition phase, from the go-live phase to self-sufficient logistics operation, according to the processes and the communication plan selected for the transition phase.

2. The method of claim 1, wherein the program development phase further includes:
setting a timeline for logistics processes included in the new logistics program; and
setting one or more customer requirements for logistics processes included in the new logistics program.

3. The method of claim 1, wherein the processes included in the pilot phase further include:
hiring and training a staff to execute the new logistics program; and
drafting logistics documentation for use in the new logistics program.

4. The method of claim 1, wherein the processes included in the go-live phase further include:
executing grief procedures that determine how to handle logistics process problems for the new logistics program; and
validating readiness for full production volume.

5. The method of claim 1, wherein the processes included in the transition phase further include:
removing a support team from the new logistics program.

6. The method of claim 1, further comprising:
at the end of each phase, evaluating the execution of the phase by a review team.

7. The method of claim 1, further comprising:
assessing risks of the new logistics program during one or more phases of the start-up model.

8. The method of claim 1, further comprising:
executing a post-implementation assessment of the new logistics program after the program operates self-sufficiently for a predefined period of time.

9. The method of claim 8, further comprising:
during the program development phase, selecting one or more metrics to evaluate for the post-implementation assessment.

10. The method of claim 9, further comprising:
selecting one or more of the metrics according to contractual terms reviewed during the program development phase.

11. The method of claim 8, further comprising:
evaluating the post-implementation assessment to determine which processes in the start-up model need improvement.

12. The method of claim 1, further comprising:
using a computer application program to store information related to the processes reviewed at each phase.

13. The method of claim 1, wherein executing the plurality of start-up model phases includes:
executing the same set of program development, pilot, go-live, and transition phases, as a standard set of phases, for all new logistics programs implemented by the program developer entity.

14. The method of claim 1, further including:
assessing safety measures of the new logistics program during one or more of the start-up model phases.

15. A method for implementing a new logistics program, comprising:
executing a plurality of start-up program phases for the new logistics program, the start-up program phases including at least a program development phase, a pilot phase, a go-live phase, and a transition phase;
during the program development phase, providing one or more review members to select, for each of the pilot, go-live, and transition phases, processes to review for the respective phase and a communication plan to execute between a program developer entity and a program client entity during the respective phase;
providing one or more pilot members to pilot the new logistics program during the pilot phase, according to the processes and the communication plan selected for the pilot phase;
providing one or more operation members to conduct real-time operation of the new logistics program during the go-live phase, according to the processes and the communication plan selected for the go-live phase; and
providing one or more transition members to transition the new logistics program, during the transition phase, from the go-live phase to self-sufficient logistics operation, according to the processes and the communication plan selected for the transition phase.

16. The method of claim 15, further including:
providing one or more evaluation members to evaluate the execution of each phase according to the processes selected for review for that phase.

17. The method of claim 16, wherein providing the one or more evaluation members includes:
evaluating the execution of each phase by at least one of: one or more members from a developer entity, and one or more members from a client entity.

18. The method of claim 15, further including:
providing a support team to help transition the new logistics program;
removing the support team from the new logistics program before beginning self-sufficient logistics operation; and
executing the self-sufficient logistics operation after completing a review of the transition phase.

19. The method of claim 18, further including:
executing a post-implementation assessment of the new logistics program a pre-determined period of time after beginning executing the self-sufficient logistics operation.

20. The method of claim 19, further including:
evaluating the new logistics program against a set of metrics during the post-implementation assessment, the set of metrics including at least one metric corresponding to at least one respective metric established in a contract between the program developer entity and the program client entity.
